(19) United States
(12) Patent Application Publication
(10) Pub. No.: US 2026/0202061 A1
(43) Pub. Date: Jul. 16, 2026

(54) COMBUSTOR OF GAS TURBINE

(71) Applicant: KAWASAKI JUKOGYO KABUSHIKI KAISHA, Kobe-shi, Hyogo (JP)

(72) Inventor: Ryusuke MATSUYAMA, Kobe-shi, Hyogo (JP)

(73) Assignee: KAWASAKI JUKOGYO KABUSHIKI KAISHA, Kobe-shi, Hyogo (JP)

(21) Appl. No.: 19/137,528

(22) PCT Filed: Dec. 18, 2023
(86) PCT No.: PCT/JP2023/045238

§ 371 Date: Jun. 10, 2025

(30) Foreign Application Priority Data
Dec. 23, 2022 (JP) 2022-207290

(51) Int. Cl. F23R 3/60; F23R 3/00; F23R 3/06

(52) U.S. Cl. CPC F23R 3/60; F23R 3/007; F23R 3/06

(57) ABSTRACT

A combustor of a gas turbine according to one aspect of the present disclosure includes: an outside wall surrounding a combustion chamber; a liner located inside the outside wall and facing the combustion chamber; a spacer at least part of which is located between the outside wall and the liner; a fastener at least part of which is located outside the outside wall; and a fixture by which the liner is attached to the outside wall and which includes a head supporting the liner and a shaft portion penetrating the outside wall and fastened to the fastener. The fastener includes a fastener groove extending along the fixture, a first air passage being located at the fastener groove. The spacer includes a spacer groove extending along the fixture, a second air passage through which air having flowed through the first air passage flows being located at the spacer groove.

### TECHNICAL FIELD

The present disclosure relates to a combustor of a gas turbine.

### BACKGROUND ART

PTL 1 below discloses a combustor of a gas turbine which includes a liner facing a combustion chamber. The liner is attached to an outside wall by using a fixture.

### CITATION LIST

### Patent Literature

PTL 1: U.S. Patent Application Publication No. 2003/0123953, Specification

### SUMMARY OF INVENTION

### Technical Problem

Since the fixture is exposed to the combustion chamber, the fixture may increase in temperature. Therefore, the increase in the temperature of the fixture by which the liner is attached needs to be suppressed.

### Solution to Problem

A combustor of a gas turbine according to one aspect of the present disclosure includes: an outside wall surrounding a combustion chamber; a liner located inside the outside wall and facing the combustion chamber; a spacer at least part of which is located between the outside wall and the liner; a fastener at least part of which is located outside the outside wall; and a fixture by which the liner is attached to the outside wall and which includes a head supporting the liner and a shaft portion penetrating the outside wall and fastened to the fastener. The fastener includes a fastener groove extending along the fixture, a first air passage being located at the fastener groove. The spacer includes a spacer groove extending along the fixture, a second air passage through which air having flowed through the first air passage flows being located at the spacer groove.

### Advantageous Effects of Invention

The configuration according to one aspect of the present disclosure can provide the combustor of the gas turbine which can suppress the increase in the temperature of the fixture by which the liner is attached.

### BRIEF DESCRIPTION OF DRAWINGS

FIG. 1 is a sectional view of a combustor.

FIG. 2 is an enlarged view showing the vicinity of a fixture.

FIG. 3 is a diagram showing that a fastener and a spacer in FIG. 2 are cut.

FIG. 4 is a diagram viewed in a direction shown by an arrow IV of FIG. 2.

FIG. 5 is a sectional view taken along line V-V of FIG. 2.

FIG. 6 is a sectional view taken along line VI-VI of FIG. 2.

FIG. 7 is a diagram showing the combustor according to Modified Example and corresponding to FIG. 3.

### DESCRIPTION OF EMBODIMENTS

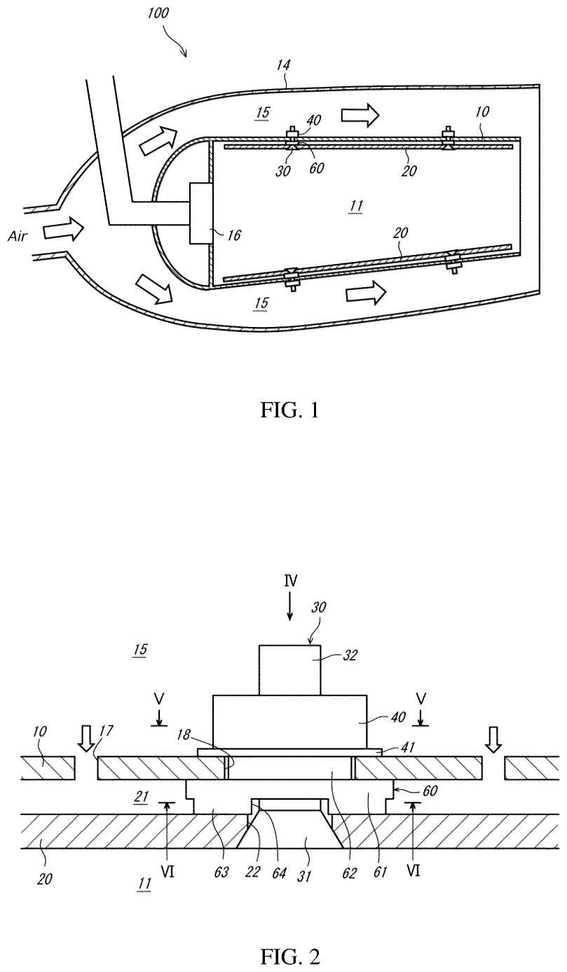

Hereinafter, a combustor 100 according to an embodiment will be described. The combustor 100 according to the present embodiment is a combustor for use in a gas turbine and is of a so-called annular type. However, the combustor 100 may be of a type, such as a can type, other than the annular type. FIG. 1 is a sectional view of a circumferential position of the combustor 100.

As shown in FIG. 1, the combustor 100 according to the present embodiment includes an outside wall 10, a liner 20, a fixture 30, a fastener 40, and a spacer 60. Hereinafter, these components will be described in order.

### Outside Wall

The outside wall 10 is a member that surrounds a combustion chamber 11. For example, the outside wall 10 includes a metal material. The outside wall 10 is made of metal. Hereinafter, by using the combustion chamber 11 as a reference, a side close to the combustion chamber 11 is referred to as an “inside,” and a side far from the combustion chamber 11 is referred to as an “outside.” The outside wall 10 is surrounded by an annular housing 14, and an outside space 15 is located outside the outside wall 10, i.e., between the outside wall 10 and the housing 14.

A fuel injector 16 is located in the combustion chamber 11, and fuel is injected from the fuel injector 16 to the combustion chamber 11. In the present embodiment, air is supplied to the housing 14, and part of the air supplied to the housing 14 is supplied to the fuel injector 16. The fuel injected from the fuel injector 16 to the combustion chamber 11 is mixed with the air and combusted. Moreover, as shown by white arrows in FIG. 1, part of the rest of the air supplied to the housing 14 is supplied to and flows in the outside space 15.

FIG. 2 is an enlarged view showing the vicinity of the fixture 30. A lower side on the paper surface of FIG. 2 is an inside, and an upper side on the paper surface of FIG. 2 is an outside. As shown by white arrows in FIG. 2, part of the air having flowed through the outside space 15 flows through an outside wall hole 17 of the outside wall 10 into a space 21 between the outside wall 10 and the liner 20. Part of the air supplied to the fuel injector 16 may flow into the space 21. Moreover, the outside wall 10 includes a through hole 18 penetrated by the fixture 30.

### Liner

The liner 20 is a member that faces the combustion chamber 11. For example, the liner 20 includes a ceramic matrix composite (hereinafter referred to as a “CMC”). The liner is made of the CMC. As shown in FIG. 1, the liner 20 is located inside the outside wall 10 and is attached to the outside wall 10 by the fixtures 30. Moreover, as shown in FIG. 2, the liner 20 includes an attachment hole 22 that receives a head 31 of the fixture 30 described below. The liner 20 may be divided into panels or may be integrally molded. Moreover, the liner 20 may include a large number of air holes for cooling.

### Fixture

The fixture 30 is a member by which the liner 20 is attached to the outside wall 10. For example, the fixture 30 includes a metal material. The fixture 30 is made of metal. As shown in FIG. 2, the fixture 30 includes the head 31 and a shaft portion 32.

The head 31 is a portion supporting the liner 20. The head 31 of the present embodiment is located in the attachment hole 22 of the liner 20. The head 31 is integrated with the shaft portion 32 and is located inside the shaft portion 32. The head 31 of the present embodiment has a truncated cone shape. The outer diameter of a portion of the head 31 which is close to the combustion chamber 11 is larger than the outer diameter of a portion of the head 31 which is close to the shaft portion 32. However, the head 31 does not have to have the truncated cone shape and may have another shape, such as a truncated pyramid shape. Since the head 31 is exposed to the combustion chamber 11, head may be transferred from the combustion chamber 11 to the head 31, and this may increase the temperature of the fixture 30.

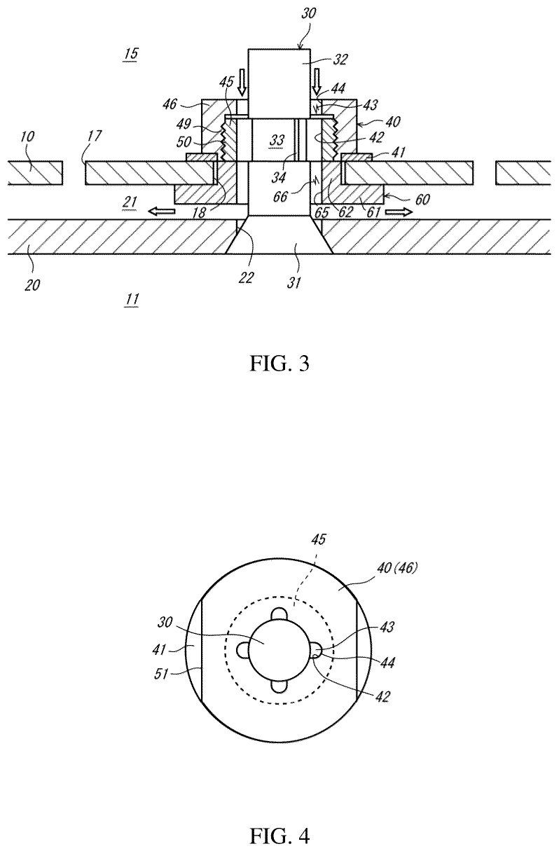

The shaft portion 32 is integrated with the head 31 and is located outside the head 31. Moreover, the shaft portion 32 penetrates the spacer 60 and the outside wall 10 and is fastened to the fastener 40. FIG. 3 is a diagram showing that the fastener 40 and the spacer 60 in FIG. 2 are cut. As shown in FIG. 3, the shaft portion 32 includes a small-diameter portion 33. The outer diameter of the small-diameter portion 33 is smaller than the outer diameter of a portion of the shaft portion 32 which is outwardly adjacent to the small-diameter portion 33 and the outer diameter of a portion of the shaft portion 32 which is inwardly adjacent to the small-diameter portion 33. Moreover, an outer peripheral surface of the small-diameter portion 33 of the shaft portion 32 includes a key 34 which extends in a central axis direction of the fixture 30 (hereinafter simply referred to as the “central axis direction”) and has a projecting section. The fixture 30 may include therein an air passage for cooling.

### Fastener

The fastener 40 is a tubular member fastened to the fixture 30. For example, the fastener 40 includes a metal material. The fastener 40 is made of metal. By fastening the fixture 30 to the fastener 40, the liner 20 can be attached to the outside wall 10. As shown in FIG. 2, the fastener 40 of the present embodiment is located outside the outside wall 10. However, part of the fastener 40 may be located in the through hole 18 of the outside wall 10. In the present embodiment, a washer 41 is located between the fastener 40 and the outside wall 10.

FIG. 4 is a diagram viewed in a direction shown by an arrow IV of FIG. 2. As shown in FIG. 4, an inner peripheral surface of the fastener 40 includes fastener grooves 42. The fastener grooves 42 included in the fastener 40 may be holes or gaps. The numbers of grooves, holes, and gaps and the shapes of the grooves, holes, and gaps are not limited. As shown in FIG. 3, each fastener groove 42 extends along the shaft portion 32 of the fixture 30, and a first air passage 43 is located between each fastener groove 42 and the fixture 30. Moreover, the fastener 40 includes an air inlet 44. The air inlet 44 is located at an outside end surface of the fastener 40 and is open to the outside space 15. The air inlet 44 can take the air, which is relatively low in temperature, of the outside space 15 into the first air passage 43. The position of the air inlet 44 is not limited to the outside end surface of the fastener 40. For example, the air inlet 44 may be located on an outer peripheral surface of the fastener 40.

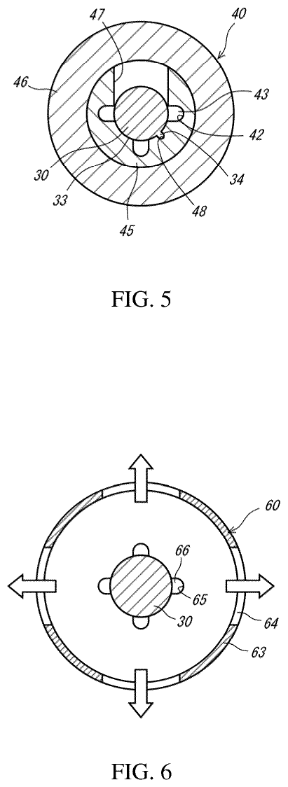

As shown in FIG. 3, the fastener 40 of the present embodiment includes a support 45 and a nut 46. The fastener 40 does not have to include the support 45. FIG. 5 is a sectional view taken along line V-V of FIG. 2. As shown in FIG. 5, the support 45 has a U shape and includes a cutout 47. A width dimension of the cutout 47 is substantially equal to the outer diameter of the small-diameter portion 33. Moreover, the inner diameter of a portion of an inner peripheral surface of the support 45 which is opposed to the small-diameter portion 33 is substantially equal to the outer diameter of the small-diameter portion 33. Therefore, the support 45 is locked to the portion which is inwardly or outwardly adjacent to the small-diameter portion 33, and this restricts the movement of the support 45 relative to the fixture 30 in the central axis direction.

Moreover, a keyway 48 extending in the central axis direction is located on the inner peripheral surface of the support 45, and the key 34 of the fixture 30 is in the keyway 48. Therefore, the rotation of the support 45 about a central axis of the fixture 30 relative to the fixture 30 is restricted. Moreover, the fastener grooves 42 are located on the inner peripheral surface of the support 45. Therefore, the first air passage 43 is located also between the fixture 30 and the support 45. Furthermore, as shown in FIG. 3, an outer peripheral surface of the support 45 includes an external thread 49.

In the present embodiment, the movement and rotation of the support 45 relative to the fixture 30 are restricted by using the small-diameter portion 33 and key 34 of the fixture 30. However, the movement and rotation of the support 45 relative to the fixture 30 may be restricted by using other means. For example, the movement and rotation of the support 45 relative to the fixture 30 may be restricted by, for example, welding the support 45 to the fixture 30.

The nut 46 is located so as to cover the support 45. A portion of an inner peripheral surface of the nut 46 which corresponds to the support 45 includes an internal thread 50. Therefore, by fastening the nut 46 to the support 45, the support 45 and the nut 46 can be coupled to each other, and therefore, the fixture 30 can be fastened to the fastener 40. A method of coupling the support 45 and the nut 46 may be a method other than the method using the threads. Moreover, as shown in FIG. 4, an outer peripheral surface of the nut 46 includes a flat surface portion 51 with which a fastening tool, such as a wrench, is brought into contact. The shape of the nut 46 is not limited to the shape shown in FIG. 4 and may be a hexagonal shape.

When the fastener 40 does not include the support 45, the nut 46 is coupled to the fixture 30. In this case, the inner peripheral surface of the nut 46 includes the fastener groove, and therefore, the first air passage 43 is located between the fastener groove and the fixture 30.

### Spacer

The spacer 60 is a member located such that the space 21 is located between the outside wall 10 and the liner 20. As shown in FIG. 2, the spacer 60 of the present embodiment includes: a main body portion 61 located between the outside wall 10 and the liner 20; and a projecting portion 62 located in the through hole 18 of the outside wall 10. The spacer 60 does not have to include the projecting portion 62 located in the through hole 18 of the outside wall 10. The main body portion 61 includes: legs 63 that are in contact with the liner 20; and air outlets 64 located between the legs 63. The air outlets 64 are open to the space 21. FIG. 6 is a sectional view taken along line VI-VI of FIG. 2. As shown in FIG. 6, the spacer 60 of the present embodiment includes four air outlets 64. However, the number of air outlets 64 included in the spacer 60 is not limited.

Moreover, an inner peripheral surface of the spacer 60 includes spacer grooves 65. The spacer grooves 65 included in the spacer 60 may be holes or gaps. The numbers of grooves, holes, and gaps and the shapes of the grooves, holes, and gaps are not limited. Then, as shown in FIG. 3, each spacer groove 65 extends along the shaft portion 32 of the fixture 30, and a second air passage 66 is located between each spacer groove 65 and the fixture 30. Each spacer groove 65 is located on both of an inner peripheral surface of the main body portion 61 and an inner peripheral surface of the projecting portion 62. Moreover, the spacer grooves 65 are located at the same positions as the fastener grooves 42 around the central axis. To be specific, the second air passages 66 are located on respective extended lines of the first air passages 43. Therefore, the air having flowed through the first air passages 43 flows through the second air passages 66. Then, the air having flowed through the second air passages 66 is discharged through the air outlets 64 to the space 21 (see white arrows in FIGS. 3 and 6).

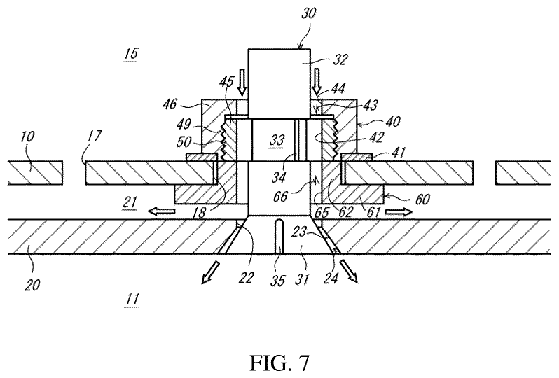

Moreover, as shown in FIG. 7, the liner 20 may include a liner groove 23. The liner groove 23 extends along the head 31 of the fixture 30, and a third air passage 24 is located between the liner groove 23 and the head 31. Then, all or part of the air having flowed through the first air passages 43 and the second air passages 66 may be discharged through the third air passage 24 to the combustion chamber 11. The liner groove 23 may be a hole or a gap. The numbers of grooves, holes, and gaps and the shapes of the grooves, holes, and gaps are not limited. Moreover, in addition to or instead of the liner groove 23 included in the liner 20, the fixture 30 may include a fixture groove 35. The fixture groove 35 extends along an outer peripheral surface of the fixture 30, and the third air passage 24 is located between the fixture groove 35 and the liner 20. The fixture groove 35 may be a hole or a gap. The numbers of grooves, holes, and gaps and the shapes of the grooves, holes, and gaps are not limited.

As above, according to the present embodiment, since the air in the outside space 15 is discharged through the first air passages 43 and the second air passages 66 to the space 21, the fixture 30 is cooled by the air, and this can suppress the increase in the temperature of the fixture 30. In addition, according to the present embodiment, the spacer 60 includes the projecting portion 62 located in the through hole 18, and the projecting portion 62 also includes the spacer grooves 65. Therefore, the first air passages 43 and the second air passages 66 are located close to each other, and this can suppress passage resistance of the air flowing along the fixture 30. Moreover, the increase in the temperature of the fixture 30 including the head 31 can be suppressed by the third air passage 24.

Moreover, the method of attaching the liner 20 to the outside wall 10 in the present embodiment is to, with the spacer 60 located between the outside wall 10 and the liner 20, insert the fixture 30 into the attachment hole 22 of the liner 20 from the combustion chamber 11 side and make the fixture 30 penetrate the outside wall 10. Then, the support 45 is made to slide in a direction perpendicular to the central axis direction of the fixture 30, and the small-diameter portion 33 of the fixture 30 is inserted into the cutout 47 of the support 45. Finally, the nut 46 is fastened to the support 45 with the washer 41 located between the liner 20 and the nut 46. Thus, the liner 20 can be attached to the outside wall 10. As above, according to the attaching method of the present embodiment, the liner 20 can be easily attached to the outside wall 10. However, the method of attaching the liner 20 to the outside wall 10 and the order of steps of attaching the liner 20 to the outside wall 10 are not limited to these.

### Conclusion

A first aspect disclosed in the present description is a combustor of a gas turbine, the combustor including: an outside wall surrounding a combustion chamber; a liner located inside the outside wall and facing the combustion chamber; a spacer at least part of which is located between the outside wall and the liner; a fastener at least part of which is located outside the outside wall; and a fixture by which the liner is attached to the outside wall and which includes a head supporting the liner and a shaft portion penetrating the outside wall and fastened to the fastener, wherein: the fastener includes a fastener groove extending along the fixture, a first air passage being located at the fastener groove; and the spacer includes a spacer groove extending along the fixture, a second air passage through which air having flowed through the first air passage flows being located at the spacer groove.

According to this configuration, since the air flows through the first air passage and the second air passage, the fixture is cooled by the air, and this can suppress the increase in the temperature of the fixture.

A second aspect disclosed in the present description is the combustor according to the first aspect, wherein: the outside wall, the fastener, and the fixture include metal; and the liner includes a CMC.

According to this configuration, the liner is made of a CMC and is higher in heat resistance than the outside wall, the fastener, and the fixture which are made of metal. Therefore, high-temperature combustion in the combustion chamber can be performed.

A third aspect disclosed in the present description is the combustor according to the first or second aspect, wherein the fastener includes an air inlet which is open to an outside space located outside the outside wall and through which the air is taken from the outside space into the first air passage.

According to this configuration, the air in the outside space which can cool the fixture can be taken into the first air passage.

A fourth aspect disclosed in the present description is the combustor according to any one of the first to third aspects, wherein the spacer includes an air outlet which is open to a space located between the outside wall and the liner and through which the air having flowed through the second air passage is discharged to the space.

According to this configuration, the air which has cooled the fixture can be utilized for cooling the liner.

A fifth aspect disclosed in the present description is the combustor according to any one of the first to fourth aspects, wherein: the fastener includes a support including an inner peripheral surface coupled to the fixture and a nut coupled to an outer peripheral surface of the support; and the fastener groove is located on the inner peripheral surface of the support.

According to this configuration, the fixture can be fastened to the fastener while securing the first air passage between the fixture and the fastener.

A sixth aspect disclosed in the present description is the combustor according to the fifth aspect, wherein the support includes a cutout in which the fixture is located and which extends in a direction perpendicular to a central axis direction of the fixture.

According to this configuration, the support can be easily fixed to the fixture, and therefore, the liner can be easily attached to the outside wall.

A seventh aspect disclosed in the present description is the combustor according to any one of the first to sixth aspects, wherein: the spacer includes a main body portion located between the outside wall and the liner and a projecting portion located in a through hole of the outside wall which is penetrated by the fixture; and the spacer groove is located at both of the main body portion and the projecting portion.

According to this configuration, since the first air passage and the second air passage are located close to each other, the passage resistance of the air flowing along the fixture can be suppressed.

An eighth aspect disclosed in the present description is the combustor according to any one of the first to seventh aspects, wherein the liner includes a liner groove extending along the head of the fixture, a third air passage being located at the liner groove.

According to this configuration, after the air flows through the first air passage and the second air passage, the air further flows through the third air passage. Thus, the fixture including the head is cooled by the air, and this can suppress the increase in the temperature of the fixture.

A ninth aspect disclosed in the present description is the combustor according to any one of the first to eighth aspects, wherein the fixture includes a fixture groove extending along the head of the fixture, a third air passage being located at the fixture groove.

According to this configuration, after the air flows through the first air passage and the second air passage, the air further flows through the third air passage. Thus, the fixture including the head is cooled by the air, and this can suppress the increase in the temperature of the fixture.

### REFERENCE SIGNS LIST

10 outside wall
11 combustion chamber
15 outside space
18 through hole
20 liner
21 space
23 liner groove
24 third air passage
30 fixture
31 head
32 shaft portion
33 small-diameter portion
35 fixture groove
40 fastener
42 fastener groove
43 first air passage
44 air inlet
45 support
46 nut
47 cutout
60 spacer
61 main body portion
62 projecting portion
64 air outlet
65 spacer groove
66 second air passage
100 combustor

1. A combustor of a gas turbine, the combustor comprising:
an outside wall surrounding a combustion chamber;
a liner located inside the outside wall and facing the combustion chamber;
a spacer at least part of which is located between the outside wall and the liner;
a fastener at least part of which is located outside the outside wall; and
a fixture by which the liner is attached to the outside wall and which includes
a head supporting the liner and
a shaft portion penetrating the outside wall and fastened to the fastener, wherein:
the fastener includes a fastener groove extending along the fixture, a first air passage being located at the fastener groove; and
the spacer includes a spacer groove extending along the fixture, a second air passage through which air having flowed through the first air passage flows being located at the spacer groove.

2. The combustor according to claim 1, wherein:
the outside wall, the fastener, and the fixture include metal; and
the liner includes a CMC.

3. The combustor according to claim 1, wherein the fastener includes an air inlet which is open to an outside space located outside the outside wall and through which the air is taken from the outside space into the first air passage.

4. The combustor according to claim 1, wherein the spacer includes an air outlet which is open to a space located between the outside wall and the liner and through which the air having flowed through the second air passage is discharged to the space.

5. The combustor according to claim 1, wherein:
the fastener includes
a support including an inner peripheral surface coupled to the fixture and
a nut coupled to an outer peripheral surface of the support; and
the fastener groove is located on the inner peripheral surface of the support.

6. The combustor according to claim 5, wherein the support includes a cutout in which the fixture is located and which extends in a direction perpendicular to a central axis direction of the fixture.

7. The combustor according to claim 1, wherein:
the spacer includes
a main body portion located between the outside wall and the liner and
a projecting portion located in a through hole of the outside wall which is penetrated by the fixture; and
the spacer groove is located at both of the main body portion and the projecting portion.

8. The combustor according to claim 1, wherein the liner includes a liner groove extending along the head of the fixture, a third air passage being located at the liner groove.

9. The combustor according to claim 1, wherein the fixture includes a fixture groove extending along the head of the fixture, a third air passage being located at the fixture groove.
